(19) United States
(12) Patent Application Publication
(10) Pub. No.: US 2015/0130573 A1
(43) Pub. Date: May 14, 2015

(54) POWDER CORE, POWDER CORE MANUFACTURING METHOD, AND METHOD FOR ESTIMATING EDDY CURRENT LOSS IN POWDER CORE

(71) Applicants: Hikaru Araki, Mie (JP); Norikazu Muneda, Mie (JP); Eiichirou Shimazu, Mie (JP)

(72) Inventors: Hikaru Araki, Mie (JP); Norikazu Muneda, Mie (JP); Eiichirou Shimazu, Mie (JP)

(73) Assignee: NTN CORPORATION, Osaka (JP)

(21) Appl. No.: 14/398,303

(22) PCT Filed: Apr. 25, 2013
(86) PCT No.: PCT/JP2013/062200

§ 371 Date: Oct. 31, 2014

(30) Foreign Application Priority Data
May 25, 2012 (JP) 2012-119873

(51) Int. Cl. H01F 3/08; H01F 41/02

(52) U.S. Cl. CPC H01F 3/08; H01F 41/0246
USPC 335/297; 419/66; 419/23

(57) ABSTRACT

An eddy current loss at a frequency of 3,000 Hz is set to less than 150 W/kg by setting a single particle diameter-equivalent diameter d_{S} of soft magnetic metal powder represented by the following formula to 210 μm or less. In the formula, d_{S} represents a single particle diameter-equivalent diameter of the soft magnetic metal powder [m], d_{MN} represents a number average particle diameter of the soft magnetic metal powder [m], and σ represents a standard deviation of the particle diameter of the soft magnetic metal powder [m].

$${d}_{S} = \sqrt{{d}_{MN}^{2} + 5 {σ}^{2} + \frac{2 {σ}^{2} {d}_{MN}^{2}}{{d}_{MN}^{2} + 3 {σ}^{2}}}$$

### TECHNICAL FIELD

The present invention relates to a powder magnetic core, a method of manufacturing a powder magnetic core, and a method of estimating an eddy current loss of a powder magnetic core.

### BACKGROUND ART

As is well known, a transformer, a step-up transformer, a rectifier, and the like are incorporated into a power source circuit, which is used by being incorporated into, for example, an electric product and a mechanical product. The transformer and the like include various coil components (such as a choke coil, a power inductor, and a reactor) each formed of a magnetic core and a winding as main parts. In order to respond to a request for low power consumption with respect to the electric product and the mechanical product on the background of increasing consciousness of energy saving in recent years, there is a demand for improvements in magnetic characteristics of the magnetic core to be used frequently in the power source circuit. Further, in recent years, with increasing consciousness of a global warming issue, there has been an increasing demand for a hybrid electric vehicle (HEV), which can suppress consumption of fossil fuel, and an electric vehicle (EV), which does not directly consume fossil fuel. Running performance and the like of the HEV and the EV depend on performance of a motor. Therefore, there is also a demand for improvements in magnetic characteristics of a magnetic core (a stator core or a rotor core) to be incorporated into various motors.

Hitherto, as the magnetic core, a so-called laminated magnetic core in which steel plates (magnetic steel plates) whose surface is coated with an insulating coating are laminated through intermediation of an adhesive layer has been widely used. However, such laminated magnetic core has a low degree of freedom of a shape and is difficult to respond to a request for miniaturization and a complicated shape. Thus, there has been developed a so-called powder magnetic core obtained by subjecting soft magnetic metal powder (metal powder having a small coercive force and a large magnetic permeability, which is generally metal powder containing iron as a main component) whose surface is coated with an insulating coating to compression molding. The powder magnetic core has been mounted on various products.

Meanwhile, as one of the effective means for improving the magnetic characteristics of the magnetic core, there is given means for decreasing the energy loss (iron loss) of the magnetic core. The iron loss is roughly divided into an eddy current loss and a hysteresis loss, and the eddy current loss has a significant impact on the energy loss of the powder magnetic core. An eddy current loss We [W/m³] is known to obey the theoretical formula represented by the following mathematical formula 1.

$$We = \frac{α}{ρ \times D} \times {Bm}^{2} \times {f}^{2} \times {d}^{2} \qquad [ Math . 1 ]$$

ρ: resistivity of soft magnetic metal powder [Ω·m]
D: density [g/cm³]
Bm: excitation magnetic flux density [T]
f: frequency [Hz]
d: thickness of steel plate or particle diameter of powder [m]
α: shape factor

As just described, the eddy current loss is proportional to a square of a thickness of the steel plate or a particle diameter of the powder, d. Accordingly, the eddy current loss can be reduced by reducing the thickness of the steel plate in the case of the laminated magnetic core or by reducing the particle diameter of the soft magnetic metal powder in the case of the powder magnetic core. However, when the thickness of the steel plate is excessively small, processing of the laminated magnetic core becomes difficult, which results in lower productivity. Similarly, when the particle diameter of the soft magnetic metal powder is excessively small, the particles hardly undergo plastic deformation during compression molding, which results in lower productivity.

Under such circumstances, the thickness of the steel plate in the case of the laminated magnetic core or the particle diameter of the powder in the case of the powder magnetic core is set to a range that can sufficiently reduce the eddy current loss and does not cause problems in processability and moldability. For example, in a powder magnetic core disclosed in Patent Literature 1, a particle diameter is set to a range of from 20 to 100 μm.

### CITATION LIST

Patent Literature 1: JP 4436172 B2

### SUMMARY OF INVENTION

### Technical Problem

In the case of the laminated magnetic core, the thickness of the steel plate d is approximately constant, and hence, the eddy current loss We can be estimated by using the theoretical formula of the above-mentioned mathematical formula 1. Accordingly, the thickness of the steel plate may be set so that the eddy current loss is equal to or less than a predetermined value. In contrast, in the case of the powder magnetic core, the soft magnetic metal powder does not have a single particle diameter but has a roughly normal particle size distribution. And hence, it is difficult to specify the value din the theoretical formula of the above-mentioned mathematical formula 1. Accordingly, estimation of the eddy current loss is difficult. Therefore, at present, the soft magnetic metal powder is empirically classified and thus its particle diameter is roughly set to the range. However, in this case, the particle diameter tends to be smaller than necessary, which may lead to lower moldability and then lower productivity of the powder magnetic core.

In view of the above-mentioned circumstances, an object of the present invention is to set a particle diameter of a soft magnetic metal powder to a proper range so that an eddy current loss of a powder magnetic core becomes sufficiently small.

### Solution to Problem

According to one embodiment of the present invention, which is devised to achieve the above-mentioned object, there is provided a powder magnetic core, comprising soft magnetic metal powder having a surface coated with an insulating coating, an estimated eddy current loss at a frequency of 3,000 Hz of the powder magnetic core being set to less than 150 W/kg by setting a single particle diameter-equivalent diameter d_{S} of the soft magnetic metal powder represented by the following mathematical formula 2 to 210 μm or less.

$${d}_{S} = \sqrt{{d}_{MN}^{2} + 5 {σ}^{2} + \frac{2 {σ}^{2} {d}_{MN}^{2}}{{d}_{MN}^{2} + 3 {σ}^{2}}} \qquad [ Math . 2 ]$$

d_{S}: single particle diameter-equivalent diameter of soft magnetic metal powder [m]
d_{MN}: number average particle diameter of soft magnetic metal powder [m]
σ: standard deviation of particle diameter of soft magnetic metal powder [m]

According to another embodiment of the present invention, which is devised to achieve the above-mentioned object, there is provided a method of manufacturing a powder magnetic core comprising soft magnetic metal powder having a surface coated with an insulating coating, the method comprising setting an eddy current loss at a frequency of 3,000 Hz to less than 150 W/kg by setting a single particle diameter-equivalent diameter d_{S} of the soft magnetic metal powder represented by the mathematical formula 2 to 210 μm or less.

According to still another embodiment of the present invention, which is devised to achieve the above-mentioned object, there is provided a method of estimating an eddy current loss of a powder magnetic core, the method comprising estimating an eddy current loss We represented by the following mathematical formula 3 based on a single particle diameter-equivalent diameter d_{S} of soft magnetic metal powder represented by the mathematical formula 2.

$$We = \frac{α}{ρ \times D} \times {Bm}^{2} \times {f}^{2} \times {d}_{S}^{2} \qquad [ Math . 3 ]$$

We: eddy current loss [W/kg]
p: resistivity of soft magnetic metal powder [Ω·m]
D: density [g/cm³]
Bm: excitation magnetic flux density [T]
f: frequency [Hz]
α: shape factor

The inventors of the present invention earnestly conducted studies. As a result, the inventors of the present invention have found that when the particle diameter of soft magnetic metal powder is evaluated as a single particle diameter-equivalent diameter d_{S} represented by the above-mentioned mathematical formula 2, a calculated current loss We obtained through calculation based on the single particle diameter-equivalent diameter d_{S} and an actually measured eddy current loss We′ are extremely highly correlated with each other (see FIG. 6). In consequence, the eddy current loss can be estimated by using the single particle diameter-equivalent diameter d_{S}. In this connection, it is possible to set the single particle diameter-equivalent diameter d_{S} so that the eddy current loss is equal to or less than a predetermined value. Specifically, it has been found that an eddy current loss at a frequency of about 3,000 Hz can be set to less than 150 W/kg by setting the single particle diameter-equivalent diameter d_{S} of soft magnetic metal powder to 210 μm or less.

When water atomized pure iron powder is used as the soft magnetic metal powder, a powder magnetic core that is excellent particularly in radial crushing strength and chipping resistance can be obtained.

When the soft magnetic metal powder is subjected to compression molding, followed by annealing treatment to remove processing strain in a compact, a powder magnetic core that is excellent particularly in magnetic characteristics can be obtained.

### Advantageous Effects of Invention

As mentioned above, according to one embodiment of the present invention, the eddy current loss of the powder magnetic core can be estimated by evaluating the particle diameter of the soft magnetic metal powder as the single particle diameter-equivalent diameter d_{S}. Therefore, the particle diameter range of the soft magnetic metal powder can be set so that the eddy current loss of the powder magnetic core becomes sufficiently small.

### BRIEF DESCRIPTION OF DRAWINGS

FIG. 1(a) is a view schematically illustrating a powder production step.

FIG. 1 (b) is a schematic cross-sectional view of powder for a magnetic core to be obtained through the powder production step.

FIG. 2 (a) is a view schematically illustrating a major part of a compression molding step.

FIG. 2 (b) is a view schematically illustrating a major part of a compression molding step.

FIG. 2(c) is a view schematically illustrating a part of a compact to be obtained through the compression molding step.

FIG. 3 is a view schematically illustrating a part of a powder magnetic core to be obtained through a heating step.

FIG. 4 is a plan view of a stator core as an example of the powder magnetic core.

FIG. 5 is a table showing production conditions for each ring-shaped test body used in confirmation tests.

FIG. 6 is a graph showing a correlation between a calculated eddy current loss and an actually measured eddy current loss.

### DESCRIPTION OF EMBODIMENTS

Embodiments of the present invention are hereinafter described with reference to the drawings.

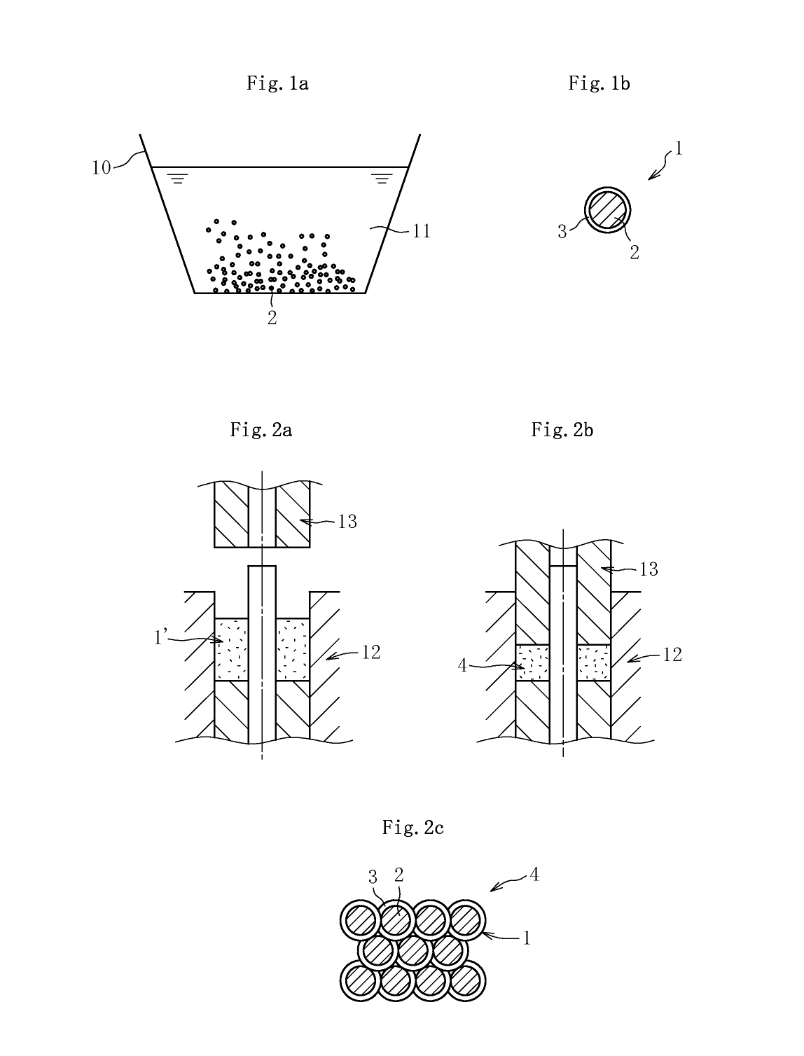

A method of manufacturing a powder magnetic core according to an embodiment of the present invention mainly comprises: a powder production step of producing powder for a magnetic core 1 illustrated in FIG. 1(b); a compression molding step of obtaining a compact 4 of the powder for a magnetic core 1 illustrated in FIG. 2(c); and a heating step of performing heat treatment on the compact 4. Each step is hereinafter described in detail with reference to the drawings.

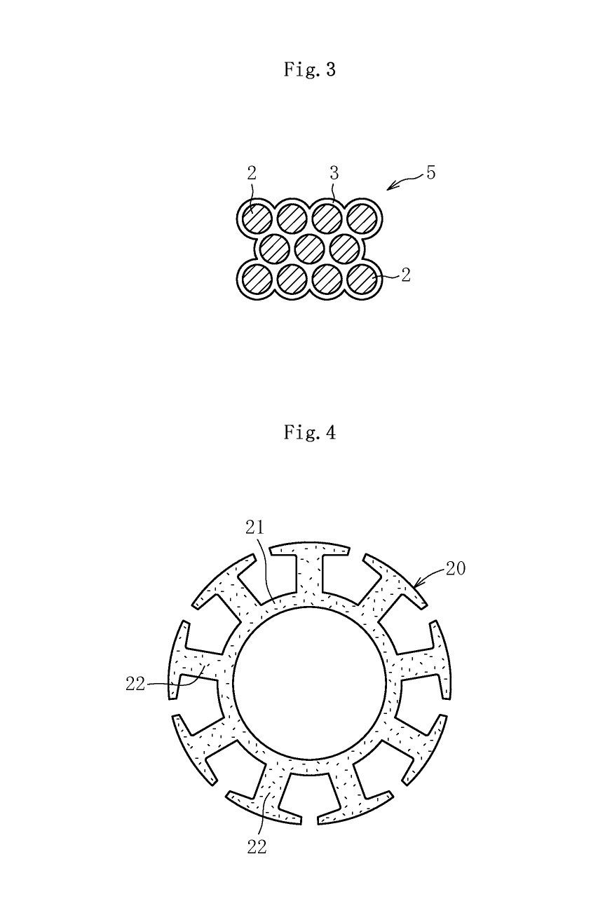

FIG. 1(a) schematically illustrates apart of the powder production step of producing the powder for a magnetic core 1 illustrated in FIG. 1(b). In the powder production step, soft magnetic metal powder 2 is soaked in a container 10 filled with a solution 11 comprising a compound that is to serve as an insulating coating 3, and then, a liquid component of the solution 11 is removed. Thus, the powder for a magnetic core 1 comprising the soft magnetic metal powder 2 and the insulating coating 3 for coating the surface of the soft magnetic metal powder 2 is obtained. As the thickness of the insulating coating 3 increases, it becomes more difficult to obtain the compact 4 having a high density, and the magnetic permeability of a powder magnetic core 5 (see FIG. 3) decreases. In contrast, as the thickness of the insulating coating 3 decreases, the magnetic characteristics (magnetic permeability) of the powder magnetic core 5 can be enhanced more. Therefore, the thickness of the insulating coating 3 is preferably 10 nm or more and 1,000 nm or less, more preferably 10 nm or more and 200 nm or less, still more preferably 10 nm or more and 100 nm or less.

The soft magnetic metal powder 2 that can be used is not particularly limited. Depending on required characteristics, the soft magnetic metal powder 2 is appropriately selected from known soft magnetic metal powders such as pure iron (Fe) powder, silicon alloy (Fe—Si) powder, sendust (Fe—Al—Si) powder, and permendur (Fe—Co) powder, and used. It should be noted that, when the silicon alloypowder or sendust powder is used as the soft magnetic metal powder 2, there is some difficulty in obtaining a powder magnetic core having a sufficiently high saturation magnetic flux density. In addition, the obtained powder magnetic core is highly likely to be unfit for applications requiring a powder magnetic core with a smaller size and higher power. Moreover, when the permendur powder is used as the soft magnetic metal powder 2, although a powder magnetic core having a high saturation magnetic flux density is obtained, there is some difficulty in obtaining a powder magnetic core having a high density because such powder is relatively expensive, and in addition, undergoes less plastic deformation owing to a high modulus of elasticity. In contrast, when the pure iron powder is used as the soft magnetic metal powder 2, a powder magnetic core having a relatively high density and a high saturation magnetic flux density can be obtained easily at relatively low cost. Accordingly, the pure iron powder is used as the soft magnetic metal powder 2 here.

Any of reduced pure iron powder produced by a reduction method, atomized pure iron powder produced by an atomizing method, and an electrolytic pure iron powder produced by an electrolytic method may be used as the pure iron powder. Of those, atomized pure iron powder, which has a relatively high purity, is excellent in magnetic characteristics, has a low modulus of elasticity (is excellent in plastic deformation property), and is easily molded into a compact (powder magnetic core) having a high density, is preferably used. It should be noted that the atomized pure iron powder is roughly classified into water atomized pure iron powder produced by a water atomizing method and gas atomized pure iron powder produced by a gas atomizing method. While the gas atomized pure iron powder has a high purity, there is some difficulty in enhancing the chipping resistance of the powder magnetic core owing to lower mutual adhesiveness due to its spherical shape. In view of the foregoing studies, when the atomized pure iron powder is used as the soft magnetic metal powder 2, it is most preferred to select and use the water atomized pure iron powder. It should be noted that carbonyl iron powder is also available as a fine particle grade, but its particle diameter is small and the resultant compact is liable to have defects such as cracks and chips.

When the particle diameter of the soft magnetic metal powder 2 is excessively small, for example when the single particle diameter-equivalent diameter d_{S} represented by the above-mentioned mathematical formula 2 is 13 μm, the powder hardly undergoes plastic deformation in the compression molding step described later, and pores are liable to remain in the inside of the compact. Accordingly, it is difficult to obtain a compact having a high density. In addition, the compact may have cracks or chips. When the single particle diameter-equivalent diameter is 28 μm, no cracks and chips were observed in the molded article. Therefore, a thickness of about 20 μm is required for securing the moldability. In contrast, when the particle diameter of the soft magnetic metal powder 2 to be used is excessively large, the eddy current loss of the powder magnetic core increases. Accordingly, there is a need to set the particle diameter of the soft magnetic metal powder 2 to a predetermined range. Herein, when the particle diameter of the soft magnetic metal powder 2 is evaluated as the single particle diameter-equivalent diameter d_{S}, it is possible to appropriately estimate the eddy current loss We by using the above-mentioned mathematical formula 3. The range of the single particle diameter-equivalent diameter d_{S} is set so that the eddy current loss We thus estimated is equal to or less than a predetermined value. In this embodiment, the single particle diameter-equivalent diameter d_{S} of the soft magnetic metal powder 2 is set to 210 μm or less so that the eddy current loss is less than 150 W/kg. Further, when the single particle diameter-equivalent diameter is set to 100 μm or less, it is possible to suppress the eddy current loss to less than 30 W/kg by virtue of the smaller particle diameter. As mentioned above, in this embodiment, the single particle diameter-equivalent diameter d_{S} of the soft magnetic metal powder 2 is set to a range of from 20 to 210 μm, preferably from 30 to 100 μm.

Specifically, the soft magnetic metal powder 2 is classified so as to have a particle size distribution with an appropriate number average particle diameter d_{MN} and an appropriate standard deviation σ. With this, the single particle diameter-equivalent diameter d_{S} of the soft magnetic metal powder 2 is set to the above-mentioned range. The classification may be conducted before or after the soft magnetic metal powder is coated with the insulating coating. This is because the thickness of the insulating coating is much smaller than the particle diameter of the soft magnetic metal powder. It should be noted that the number average particle diameter d_{MN} and standard deviation σ required for calculation of the single particle diameter-equivalent diameter d_{S} can be measured with a laser diffraction/scattering particle size distribution measuring device, for example.

The number average particle diameter d_{MN} is represented by the following mathematical formula 4, given that a group of soft magnetic metal powders contains particles having particle diameters (equal volume sphere equivalent particle diameter, the same shall apply hereinafter) of d₁, d₂, . . . dᵢ, dₖ in ascending order at the number of particles of n₁, n₂, . . . nₖ, respectively.

$$\begin{matrix}{d}_{MN} = \frac{{n}_{1} \cdot {d}_{1} + {n}_{2} \cdot {d}_{2} + … + {n}_{i} \cdot {d}_{i} + … + {n}_{k} \cdot {d}_{k}}{{n}_{1} + {n}_{2} + … + {n}_{i} + … + {n}_{k}} \\ = \frac{\sum ( {n}_{i} \cdot {d}_{i} )}{\sum ( {n}_{i} )}\end{matrix} \qquad [ Math . 4 ]$$

The standard deviation σ can be determined by any one of the following two methods. First, when the average particle diameter of the group of soft magnetic metal powders is defined as d_{ave.}, the standard deviation σ is represented by the following mathematical formula 5.

$$σ = \sqrt{\frac{1}{k} {\sum }_{i = 1}^{k} {( {d}_{i} - {d}_{ave .} )}^{2}} \qquad [ Math . 5 ]$$

Alternatively, the standard deviation σ can be calculated using a cumulative curve determined on the basis of the number-size distribution of the particle diameter. For example, the standard deviation σ can be determined by reading the particle diameter d₁₆% at which the cumulative curve has a value of 16% and the particle diameter d₈₄% at which the cumulative curve has a value of 84%, and using the following mathematical formula 6.

$$σ = \frac{( {d}_{84 \%} - {d}_{16 \%} )}{2} \qquad [ Math . 6 ]$$

It should be noted that, in using the soft magnetic metal powder 2 having a particle diameter in the above-mentioned numerical range, its actual particle diameter is measured by photographing the external appearance of the metal powder obtained through the classification with a scanning electron microscope (SEM). In addition, for the molded article (compact 4), the particle diameter of the powder contained in the molded article is measured by unidirectionally scrapping the cross section of the molded article little by little with a ion beam, and concurrently shooting an image of the every scrapped surface with a scanning electron microscope, and constructing a three-dimensional image through image processing of the images of the cross section.

The insulating coating is formed of a compound that is joined to each other in a state of a solid phase without being liquefied when the compact is heated in the heating step described later at a temperature equal to or more than the recrystallization temperature and equal to or less than the melting point of the soft magnetic metal powder. Specifically, the insulating coating is formed of a compound having a melting temperature of more than 700° C. and less than 1,600° C. Of those compounds satisfying such conditions, iron oxide (Fe₂O₃), sodium silicate (Na₂SiO₃), potassium sulfate (K₂SO₄), sodium borate (Na₂B₄O₇), potassium carbonate (K₂CO₃), boron phosphate (BPO₄), and iron sulfide (FeS₂) are particularly preferred. It should be noted that compounds other than these compounds, including: other oxides such as silicon oxide and tungsten oxide; other silicates such as aluminum silicate, potassium silicate, and calcium silicate; other borates such as lithium borate, magnesium borate, and calcium borate; other carbonates such as lithium carbonate, sodium carbonate, aluminum carbonate, calcium carbonate, and barium carbonate; and other phosphates typified by potassium phosphate may be used to form the insulating coating.

Next, in the compression molding step schematically illustrated in FIGS. 2(a) and 2(b), the compact 4 schematically illustrated in FIG. 2(c) is obtained through compression molding using a mold including a die 12 and a punch 13 disposed coaxially. In this embodiment, mixed powder 1′ containing an appropriate amount of a solid lubricant, with the balance being the powder for a magnetic core 1, is used to be subjected to compression molding, to form the compact 4. As just described, when the mixed powder 1′ containing a solid lubricant is used, the friction between the powders for a magnetic core 1 can be reduced during molding into the compact 4. Accordingly, the damage, peeling, and the like of the insulating coating 3 caused by the friction between the powders for a magnetic core 1 can also be prevented as much as possible, in addition to the ease of obtaining the compact 4 having a high density. It should be noted that the solid lubricant that may be used is not particularly limited, and there may be used, for example: metal soap such as zinc stearate or calcium stearate; a fatty acid amide such as stearamide or ethylene bis (stearamide); graphite; and molybdenum disulfide. One kind of the solid lubricants may be used alone, or two or more kinds thereof may be used as a mixture.

It should be noted that, in the case where the blending amount of the solid lubricant occupying the raw material powder 1′ is excessively small, specifically, in the case where the blending amount of the solid lubricant is less than 1.0 vol % when the total amount of the raw material powder 1′ is defined as 100 vol %, the above-mentioned advantages exhibited by mixing the solid lubricant cannot be effectively obtained. Further, in the case where the blending amount of the solid lubricant is excessively large, specifically, in the case where the blending amount of the solid lubricant is more than 10 vol %, the occupying amount of the solid lubricant in the raw material powder 1′ becomes too large, and consequently it becomes difficult to obtain the compact 4 and powder magnetic core 5 having a high density. Thus, in the case of compression molding into the compact 4 through use of the raw material powder 1′ containing a solid lubricant, it is desired to use the raw material powder 1′ containing from 1.0 to 10 vol %, preferably from 1 to 3 vol % of a solid lubricant, with the balance being the powder for a magnetic core 1.

In the above-mentioned configuration, as illustrated in FIGS. 2 (a) and 2 (b), the mixed powder 1′ is filled into the cavity of the mold, and then subjected to compression molding into the compact 4 by relatively moving the punch 13 so as to be close to the die 12. The molding pressure is set to a pressure at which the powder for a magnetic core (soft magnetic metal powder and insulating coating) undergoes plastic deformation and the contact area between the powders for a magnetic core adjacent to each other can be increased, for example, 690 MPa or more. In this embodiment, the single particle diameter-equivalent diameter d_{S} of the soft magnetic metal powder is set to 30 μm or more as described above, and hence, the particles can sufficiently undergo plastic deformation by pressing force applied during the compression molding, which allows for an increased density. Thus, as schematically illustrated in FIG. 2(c), the compact 4 having a high density in which the powders for a magnetic core 1 are in strong contact with each other is obtained. Particularly when the molding pressure is set to 980 MPa or more, the compact 4 having a higher density is obtained.

The compact 4 obtained through the compression molding step is transferred to the heating step. In the heating step, the compact 4 in the atmosphere, an atmosphere of inert gas (for example, nitrogen gas), or under a vacuum is heated at a temperature equal to or more than the recrystallization temperature and equal to or less than the melting point of the soft magnetic metal powder 2. Thus, the processing strain (residual strain) accumulated in the compact 4 (metal powder 2) in the compression molding step is removed. In this embodiment, the pure iron powder is used as the metal powder 2, and the processing strain in the pure iron can be completely removed by performing heat treatment at 650° C. or more for a predetermined time period. It should be noted that, in the case where the insulating coating is formed of a phosphate-based inorganic coating, it is preferred to adopt annealing conditions of 530° C.×10 min with a view to preventing the insulating coating from being damaged. When the heat treatment is performed at such heating temperature, the powder magnetic core 5 having a high density, in which the processing strain accumulated in the compact 4 (metal powder 2) is removed and the insulating coatings 3 coating the surfaces of the metal powders 2 are joined to each other in a state of a solid phase without being liquefied, is obtained (see FIG. 3). It should be noted that the solid phase joining state between the insulating coatings 3 is achieved through solid phase sintering or a dehydration condensation reaction. Whether the insulating coatings 3 are joined to each other through solid phase sintering or dehydration condensation varies depending on the kind of the compound to be used for forming the insulating coatings 3.

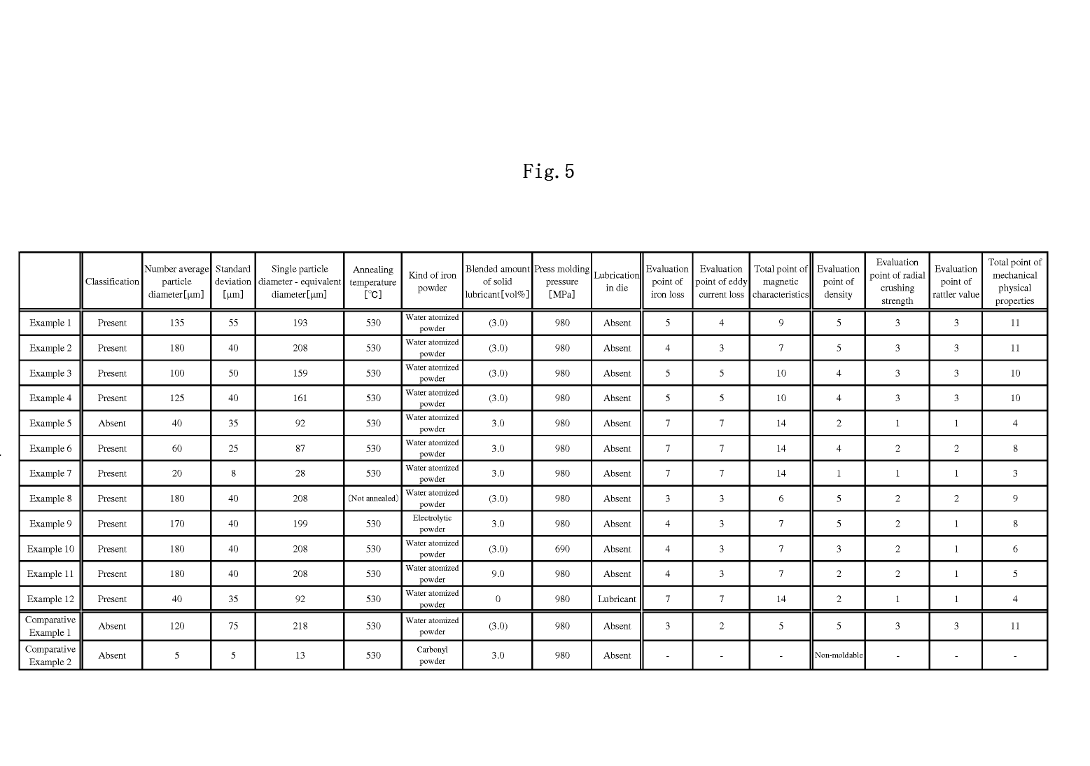

The powder magnetic core 5 obtained as described above can exhibit an eddy current loss We of less than 150 W/kg at a frequency of 3,000 Hz by setting the single particle diameter-equivalent diameter d_{S} of the soft magnetic metal powder 2 to a range of from 30 to 210 μm. With this, its magnetic characteristics can be enhanced. Accordingly, the powder magnetic core can be preferably used as magnetic cores of components for power source circuits, such as a choke coil, a power inductor, and a reactor, as well as motors for vehicles such as automobiles and railroad vehicles. Specifically, the powder magnetic core 5 according to the present invention can be used as a stator core 20 as illustrated in FIG. 4. The stator core 20 illustrated in FIG. 4 is usedbybeing integrated, for example, with a base member forming a stationary side of various motors, and includes a cylindrical portion 21 having an attachment surface with respect to the base member and a plurality of protrusions 22 extending radially from the cylindrical portion 21 to the outside in a radial direction, in which a coil (not shown) is wound around the outer circumference of the protrusions 22. The powder magnetic core 5 has a high degree of freedom of a shape, and hence, even the stator core 20 having a complicated shape as illustrated in FIG. 4 can be easily mass-produced.

In the foregoing, the powder for a magnetic core 1 according to the embodiment of the present invention and the powder magnetic core 5 produced through use of the powder for a magnetic core 1 have been described. However, the powder for a magnetic core and the powder magnetic core 6 can be appropriately modified within the range not departing from the gist of the present invention.

For example, in the compression molding into the compact 4, mold lubrication may be performed. This reduces the friction force between the inner wall surface of the mold and the raw material powder 1′ (powder for a magnetic core 1). Thus, the compact 4 can be rendered dense further easily. The mold lubrication can be performed, for example, by applying a lubricant such as zinc stearate to the inner wall surface of the mold, or by subjecting the inner wall surface of the mold to surface treatment and coating the inner wall surface with a lubricant coating.

In order to verify the usefulness of the present invention, ring-shaped test pieces having the configuration of the present invention (Examples 1 to 11) and ring-shaped test pieces not having the configuration of the present invention (Comparative Examples 1 and 2) were each subjected to confirmation tests for measuring and calculating the following evaluation items: (1) iron loss; (2) eddy current loss; (3) density; (4) radial crushing strength; and (5) rattler value. Based on the test results, the test pieces were each evaluated for the respective items (1) to (5) on a five-point scale or a seven-point scale. Then, the magnetic characteristics of each ring-shaped test piece were evaluated by a total value of evaluation points of the items (1) iron loss and (2) eddy current loss. The mechanical physical properties of each ring-shaped test piece were evaluated by a total value of evaluation points of the items (3) density, (4) radial crushing strength, and (5) rattler value. First, methods for the confirmation tests for the evaluation items (1) to (5) and evaluation points thereof are described in detail hereinafter.

(1) Iron loss

The iron loss [W/kg] at a frequency of 3,000 Hz was measured at an excitation magnetic flux density of 1 [T] with an AC B-H measurement unit (B-H analyzer SY-8218 manufactured by Iwatsu Test Instruments Corporation). The following evaluation points were given in accordance with the measured value.

7 points: less than 330 W/kg

6 points: 330 W/kg or more and less than 360 W/kg

5 points: 360 W/kg or more and less than 390 W/kg

4 points: 390 W/kg or more and less than 420 W/kg

3 points: 420 W/kg or more and less than 450 W/kg

2 points: 450 W/kg or more and less than 480 W/kg

1 point: 480 W/kg or more

(2) Eddy Current Loss

The iron loss [W/kg] at a frequency of 3,000 Hz was measured at an excitation magnetic flux density of 1 [T] with an AC B-H measurement unit (B-H analyzer SY-8218 manufactured by Iwatsu Test Instruments Corporation). Based on the measured value, the eddy current loss was determined by a least-square method. The following evaluation points were given in accordance with the determined eddy current loss value.

7 points: less than 30 W/kg

6 points: 30 W/kg or more and less than 60 W/kg

5 points: 60 W/kg or more and less than 90 W/kg

4 points: 90 W/kg or more and less than 120 W/kg

3 points: 120 W/kg or more and less than 150 W/kg

2 points: 150 W/kg or more and less than 180 W/kg

1 point: 180 W/kg or more

(3) Density

The size and weight of each ring-shaped test piece were measured, and the density thereof was calculated from the measurement results. The following evaluation points were given to the ring-shaped test piece in accordance with the calculated values. In addition, ring-shaped test pieces having defects such as cracks or chips were evaluated as “Non-moldable”.

5 points: 7.5 g/cm³ or more

4 points: 7.4 g/cm³ or more and less than 7.5 g/cm³

3 points: 7.3 g/cm³ or more and less than 7.4 g/cm³

2 points: 7.2 g/cm³ or more and less than 7.3 g/cm³

1 point: less than 7.2 g/cm³

(4) Radial Crushing Strength

A compression force (compression speed: 1.3 mm/min) in a reduced diameter direction was applied to an outer circumferential surface of each ring-shaped test piece through use of a precision universal tester Autograph AG-XPlus manufactured by Shimadzu Co., Ltd., and a compression force at a time when the ring-shaped test piece was broken divided by a broken cross-sectional area was defined as radial crushing strength [MPa]. The following evaluation points were given in accordance with the calculated value.

5 points: 100 MPa or more

4 points: 80 MPa or more and less than 100 MPa

3 points: 60 MPa or more and less than 80 MPa

2 points: 40 MPa or more and less than 60 MPa

1 point: less than 40 MPa

(5) Rattler value (weight reduction ratio)

Compliant with “Rattler value measurement method for metal compact” stipulated under the specification JPMA P11-1992 of Japan Powder Metallurgy Association. Specifically, a ring-shaped test piece loaded into an activity wheel of a rattler measurement unit was rotated 1,000 times, and thereafter, the weight reduction ratio [%] of the ring-shaped test piece was calculated as a rattler value as an indicator of chipping resistance. The following evaluation points were given in accordance with the calculated value.

5 points: less than 0.08%

4 points: 0.08% or more and less than 0.11%

3 points: 0.11% or more and less than 0.14%

2 points: 0.14% or more and less than 0.17%

1 point: 0.17% or more

Next, a method of producing a ring-shaped test piece according to Examples 1 to 11 is described.

### Example 1

Somaloy 700 3P (“Somaloy” is a trademark) manufactured by Hoeganaes AB including pure iron powder coated with an insulating coating and including about 3.0 vol % of a solid lubricant was classified to obtain pure iron powder with a coating, having a number average particle diameter of 135 μm and a standard deviation of 55 μm. The obtained powder was filled into a press mold, and molded at a molding pressure of 980 MPa into a ring-shaped compact having an outer diameter of 20.1 mm, an inner diameter of 12.9 mm, and a size in the axial direction of 7 mm. Finally, the ring-shaped compact was subjected to heat treatment (annealing) at 530° C.×10 min under a nitrogen atmosphere to obtain a ring-shaped test piece of Example 1. It should be noted that the number average particle diameter and standard deviation of the pure iron powder were measured with a laser diffraction/scattering particle size distribution measuring device MT-3000 manufactured by NIKKISO CO., LTD.

### Example 2

Somaloy 700 3P manufactured by Hoeganaes AB was classified to obtain pure iron powder with a coating, having a number average particle diameter of 180 μm and a standard deviation of 40 μm. The obtained powder was molded and annealed under the same conditions as in Example 1. Thus, a ring-shaped test piece of Example 2 was obtained.

### Example 3

Somaloy 700 3P manufactured by Hoeganaes AB was classified to obtain pure iron powder with a coating, having a number average particle diameter of 100 μm and a standard deviation of 50 μm. The obtained powder was molded and annealed under the same conditions as in Example 1. Thus, a ring-shaped test piece of Example 3 was obtained.

### Example 4

Somaloy 700 3P manufactured by Hoeganaes AB was classified to obtain pure iron powder with a coating, having a number average particle diameter of 125 μm and a standard deviation of 40 μm. The obtained powder was molded and annealed under the same conditions as in Example 1. Thus, a ring-shaped test piece of Example 4 was obtained.

### Example 5

An aqueous solution in which 0.2 mol/L of sodium dihydrogen phosphate manufactured by Wako Pure Chemical Industries, Ltd. was dissolved was prepared using pure water as a solvent. Water atomized pure iron powder 300NH (number average particle diameter: 40 μm, standard deviation: 35 μm) manufactured by Kobe Steel, Ltd. was soaked in the aqueous solution so as to be coated with an iron phosphate coating. The obtained powder was blended with 3.0 vol % of stearamide manufactured by NOF CORPORATION as a solid lubricant, and then, the mixed powder was molded and annealed under the same conditions as in Example 1. Thus, a ring-shaped test piece of Example 5 was obtained.

### Example 6

Pure iron powder with an iron phosphate coating produced in the same manner as in Example 5 was classified so as to have a number average particle diameter of 60 μm and a standard deviation of 25 μm. The obtained powder was blended with a solid lubricant, and then, molded and annealed in the same manner as in Example 5. Thus, a ring-shaped test piece of Example 6 was obtained.

### Example 7

Pure iron powder with an iron phosphate coating produced in the same manner as in Example 5 was classified so as to have a number average particle diameter of 20 μm and a standard deviation of 8 μm. The obtained powder was blended with a solid lubricant, and then, molded and annealed in the same manner as in Example 5. Thus, a ring-shaped test piece of Example 7 was obtained.

### Example 8

Somaloy 700 3P manufactured by Hoeganaes AB was classified to obtain pure iron powder with a coating, having a number average particle diameter of 180 μm and a standard deviation of 40 μm. The obtained powder was molded and annealed under the same conditions as in Example 1. Thus, a ring-shaped test piece of Example 8 was obtained. Annealing was not performed.

### Example 9

Pure iron powder produced by an electrolytic method, manufactured by Wako Pure Chemical Industries, Ltd., was classified to obtain pure iron powder having a number average particle diameter of 170 μm and a standard deviation of 40 μm. After that, an aqueous solution in which 0.2 mol/L of sodium dihydrogen phosphate manufactured by Wako Pure Chemical Industries, Ltd. was dissolved was prepared using pure water as a solvent, and then, the pure iron powder was soaked in the aqueous solution so as to be coated with an iron phosphate coating. The obtained powder was blended with 3.0 vol % of stearamide manufactured by NOF CORPORATION as a solid lubricant, and then, the mixed powder was molded and annealed under the same conditions as in Example 1. Thus, a ring-shaped test piece of Example 9 was obtained.

### Example 10

Somaloy 700 3P manufactured by Hoeganaes AB was classified to obtain pure iron powder with a coating, having a number average particle diameter of 180 μm and a standard deviation of 40 μm. The obtained powder was filled into a press mold, and molded at a molding pressure of 690 MPa into a ring-shaped compact having the same shape as that of Example 1. After that, the ring-shaped compact was annealed under the same conditions as in Example 1. Thus, a ring-shaped test piece of Example 10 was obtained.

### Example 11

Somaloy 700 3P manufactured by Hoeganaes AB was classified to obtain pure iron powder with a coating, having a number average particle diameter of 180 μm and a standard deviation of 40 μm. The obtained powder was blended with 6.0 vol % of stearamide manufactured by NOF CORPORATION as a solid lubricant so that the total amount of the solid lubricant in combination with a solid lubricant originally contained in Somaloy 700 3P became 9.0 vol %. The obtained mixed powder was molded and annealed under the same conditions as in Example 1. Thus, a ring-shaped test piece of Example 11 was obtained.

### Example 12

An aqueous solution in which 0.2 mol/L of sodium dihydrogen phosphate manufactured by Wako Pure Chemical Industries, Ltd. was dissolved was prepared using pure water as a solvent. Water atomized pure iron powder 300NH (number average particle diameter: 40 μm, standard deviation: 35 μm) manufactured by Kobe Steel, Ltd. was soaked in the aqueous solution so as to be coated with an iron phosphate coating. The obtained powder was molded under the same conditions as in Example 1. As this time, zinc stearate (particle diameter: 0.8 μm) manufactured by NOF CORPORATION was applied onto a molding surface for molding a compact in the mold. After that, the resultant was annealed under the same conditions as in Example 1. Thus, a ring-shaped test piece of Example 12 was obtained.

Finally, methods of producing a ring-shaped test piece according to Comparative Examples 1 and 2 are described.

### Comparative Example 1

Somaloy 700 3P manufactured by Hoeganaes AB was filled into a mold without being classified, and then, molded and annealed under the same conditions as in Example 1. Thus, a ring-shaped test piece of Comparative Example 1 was obtained.

### Comparative Example 2

An aqueous solution in which 0.2 mol/L of carbonyl iron powder CS manufactured by BASF Industries, Ltd. was dissolved was prepared using pure water as a solvent. Carbonyl iron powder CS (number average particle diameter: 5 μm, standard deviation: 5 μm) manufactured by BASF was soaked in the aqueous solution so as to be coated with an iron phosphate coating. The obtained powder was blended with 3.0 vol % of stearamide manufactured by NOF CORPORATION as a solid lubricant, and then, the mixed powder was molded and annealed under the same conditions as in Example 1. Thus, a ring-shaped test piece of Comparative Example 2 was attempted to be obtained.

For each of the ring-shaped test pieces according to Examples 1 to 12 and Comparative Example 1, FIG. 5 shows evaluation points of (1) iron loss, (2) eddy current loss, (3) density, (4) radial crushing strength, and (5) rattler value, the total value (total point of magnetic characteristics) of the evaluation items (1) and (2), and the total value (total point of mechanical physical properties) of the evaluation items (3) to (5). As apparent from FIG. 5, in Examples 1 to 12, in which the single particle diameter-equivalent diameter is 210 μm or less, the evaluation point of eddy current loss is 3 points or more. Of those, in Examples 5 and 6, in which the single particle diameter-equivalent diameter is as significantly small as 100 μm or less, the evaluation points of eddy current loss and iron loss are remarkably high (7 points). In contrast, in Comparative Example 1, in which the single particle diameter-equivalent diameter exceeds 210 μm, the eddy current loss is 150 W/kg or more (evaluation point: 2 points). In addition, Comparative Example 2, in which the single particle diameter-equivalent diameter fell below 20 μm, was taken as non-moldable because cracks and chips occurred in the compact. These results revealed that a powder magnetic core having an eddy current loss at a frequency of 3,000 Hz of less than 150 W/kg was obtained by setting the single particle diameter-equivalent diameter to a range of from 20 to 210 μm as in Examples 1 to 12.

In addition, Example 2 involving annealing treatment to remove processing strain has excellent magnetic characteristics as compared to Example 8 not involving annealing. Accordingly, it is preferred to perform annealing treatment on the powder magnetic core.

Further, as compared to Example 9 using electrolytic powder, Example 1 using water atomized powder is excellent in both the magnetic characteristics and the mechanical characteristics, while the density is comparable. Accordingly, it is preferred to use water atomized powder as the pure iron powder.

Further, Example 2 adopting a molding pressure of 980 MPa is excellent in the density, radial crushing strength, and rattler value as compared to Example 10 adopting a molding pressure of 680 MPa. Accordingly, a higher molding pressure is desired.

Further, Example 2 including 3.0 vol % of a solid lubricant has a high density and excellent mechanical physical properties as compared to Example 11 including 9.0 vol % of a solid lubricant. This is because as the blended amount of a solid lubricant increases, the blended amount of pure iron powder (soft magnetic metal powder) decreases. Accordingly, the blended amount of a solid lubricant is desirably as small as possible, for example, is 5.0 vol % or less, preferably 3.0 vol % or less.

Further, Example 5, in which a solid lubricant was blended, has comparable magnetic characteristics and mechanical physical properties as compared to Example 12, in which molding was performed with applying a lubricant onto the mold instead of blending a solid lubricant.

It is verified from the foregoing confirmation test results that the powder for a magnetic core according to the present invention is very useful for obtaining a powder magnetic core excellent in magnetic characteristics and various strengths.

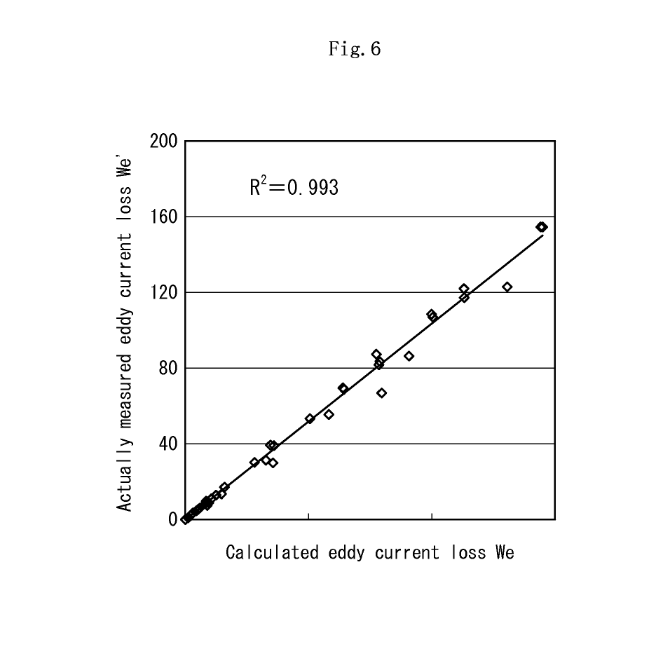

FIG. 6 shows a correlation between actually measured eddy current losses We′, which are obtained by using the ring-shaped test pieces of Examples 1 to 4 and Comparative Example 1 at an excitation magnetic flux density of 1 T at an arbitrary frequency, and calculated eddy current losses We, which are determined through the substitution into the above-mentioned mathematical formula 3. As a result, it was confirmed that there was a high correlation with a contribution ratio of 0.993 between the actually measured eddy current losses We′ and the calculated eddy current losses We. With this, the reliability of the above-mentioned mathematical formula 3 was able to be confirmed. Accordingly, it is possible to estimate the eddy current loss We from the single particle diameter-equivalent diameter d_{S} of a powder magnetic core material by using the above-mentioned mathematical formula 3. On the other hand, it is possible to estimate the single particle diameter-equivalent diameter d_{S}, and the number average particle diameter and standard deviation, of a powder magnetic core material, required for reducing the eddy current loss We.

### REFERENCE SIGNS LIST

1 powder for a magnetic core
1′ mixed powder
2 soft magnetic metal powder
3 insulating coating
4 silicate layer
5 compact
6 powder magnetic core
20 stator core

1. A powder magnetic core, comprising soft magnetic metal powder having a surface coated with an insulating coating,
a single particle diameter-equivalent diameter d_{S} of the soft magnetic metal powder represented by the following mathematical formula 1 being set to 210 μm or less, and
an eddy current loss at a frequency of 3,000 Hz of the powder magnetic core being set to less than 150 W/kg.
$${d}_{S} = \sqrt{{d}_{MN}^{2} + 5 {σ}^{2} + \frac{2 {σ}^{2} {d}_{MN}^{2}}{{d}_{MN}^{2} + 3 {σ}^{2}}} \qquad [ Math . 1 ]$$
d_{S}: single particle diameter-equivalent diameter of soft magnetic metal powder [m]
d_{MN}: number average particle diameter of soft magnetic metal powder [m]
σ: standard deviation of particle diameter of soft magnetic metal powder [m]

2. The powder magnetic core according to claim 1, wherein the soft magnetic metal powder comprises water atomized pure iron powder.

3. A method of manufacturing a powder magnetic core comprising soft magnetic metal powder having a surface coated with an insulating coating,
the method comprising setting an eddy current loss We to less than 150 W/kg by setting a single particle diameter-equivalent diameter d_{S} of the soft magnetic metal powder represented by the following mathematical formula 2 to 210 μm or less.
$${d}_{S} = \sqrt{{d}_{MN}^{2} + 5 {σ}^{2} + \frac{2 {σ}^{2} {d}_{MN}^{2}}{{d}_{MN}^{2} + 3 {σ}^{2}}} \qquad [ Math . 2 ]$$
d_{S}: single particle diameter-equivalent diameter of soft magnetic metal powder [m]
d_{MN}: number average particle diameter of soft magnetic metal powder [m]
σ: standard deviation of particle diameter of soft magnetic metal powder [m]

4. The method of manufacturing a powder magnetic core according to claim 3, wherein the soft magnetic metal powder comprises water atomized pure iron powder.

5. The method of manufacturing a powder magnetic core according to claim 3, the method comprising subjecting the soft magnetic metal powder to compression molding, followed by annealing treatment.

6. A method of estimating an eddy current loss of a powder magnetic core comprising soft magnetic metal powder having a surface coated with an insulating coating,
the method comprising estimating an eddy current loss We represented by the following mathematical formula 4 based on a single particle diameter-equivalent diameter d_{S} of the soft magnetic metal powder represented by the following mathematical formula 3.
$${d}_{S} = \sqrt{{d}_{MN}^{2} + 5 {σ}^{2} + \frac{2 {σ}^{2} {d}_{MN}^{2}}{{d}_{MN}^{2} + 3 {σ}^{2}}} \qquad$$
d_{S}: single particle diameter-equivalent diameter of soft magnetic metal powder [m]
d_{MN}: number average particle diameter of soft magnetic metal powder [m]
σ: standard deviation of particle diameter of soft magnetic metal powder [m]
$$We = \frac{α}{ρ \times D} \times {Bm}^{2} \times {f}^{2} \times {d}_{S}^{2}$$
We: eddy current loss [W/kg]
ρ: resistivity of soft magnetic metal powder [Ω·m]
D: density [g/cm³]
Bm: excitation magnetic flux density [T]
f: frequency [Hz]
α: shape factor
